(19) United States
(12) Patent Application Publication
(10) Pub. No.: US 2023/0225925 A1
(43) Pub. Date: Jul. 20, 2023

(54) GAIT REHABILITATION DEVICE

(71) Applicant: BNR CO., LTD., Incheon (KR)

(72) Inventors: Kyungchul Bae, Seoul (KR); Hunhee Kim, Jeollabuk-do (KR); Taekyeong Lee, Seoul (KR); Sungki Min, Seoul (KR)

(73) Assignee: BNR CO., LTD., Incheon (KR)

(21) Appl. No.: 18/060,065

(22) Filed: Nov. 30, 2022

(30) Foreign Application Priority Data
Jan. 19, 2022 (KR) 10-2022-0007692
Nov. 29, 2022 (KR) 10-2022-0162444

(51) Int. Cl. A61H 3/00; A61H 1/02

(52) U.S. Cl. CPC A61H 3/00; A61H 1/0262; A61H 2003/007; A61H 2201/1671; A61H 2201/5058; A61H 2201/0165; A61H 2201/1664; A61H 2201/5092; A61H 2201/5084; A61H 2201/164; A61H 2201/5069; A61H 2201/5079; A61H 2201/149

(57) ABSTRACT

The present disclosure relates to a gait rehabilitation device, and the gait rehabilitation device according to the present disclosure includes a load providing portion (200) including a body (210) and a rotating shaft (220) which rotates relative to the body (210) to generate a load, wherein the rotating shaft (220) is coupled to a side of a human body, a rotation member (300) rotatably coupled to the body (210) and coupled to an opposite side of the human body, and a rotation control portion (400) to allow or disallow the rotation member (300) to rotate relative to the load providing portion (200).

### CROSS-REFERENCE TO RELATED APPLICATION

This application claims priority to Korean Patent Application Nos. 10-2022-0007692 and 10-2022-0162444, filed on Jan. 19, 2022 and Nov. 29, 2022 respectively, and all the benefits accruing therefrom under 35 U.S.C. § 119, the contents of which in its entirety are herein incorporated by reference.

### BACKGROUND

### 1. Field

The present disclosure relates to a gait rehabilitation device.

### 2. Description of the Related Art

Currently, devices for gait rehabilitation are led by medical centers for stroke rehabilitation. However, most of them rely on high cost devices, and gait rehabilitation devices that can be used in daily life are not yet commercialized.

Additionally, there are training support services for ordinary people, but there are not many studies on customized training support services reflecting the physical characteristics of people in need of lower limb rehabilitation services. Meanwhile, the existing devices for gait rehabilitation do not have means to control loads according to wearers' conditions, so in the event of abnormal situations, for example, falls, the wearers cannot respond to the abnormal situations.

### RELATED LITERATURES

### Patent Literature

(Patent Literature 1) KR 10-2002289 B1

### SUMMARY

The present disclosure is designed to solve the above-described problem, and an aspect of the present disclosure is directed to providing a gait rehabilitation device in which in the event of an abnormal situation, for example, a fall, a rotation control portion operates to unlock the locking between a load providing portion and a rotation member to remove a load applied to a wearer to induce the wearer's free movement, thereby allowing the wearer to respond to the abnormal situation, for example, the fall.

A gait rehabilitation device according to an embodiment of the present disclosure includes a load providing portion including a body and a rotating shaft which rotates relative to the body to generate a load, wherein the rotating shaft is coupled to a side of a human body, a rotation member rotatably coupled to the body and coupled to an opposite side of the human body, and a rotation control portion to allow or disallow the rotation member to rotate relative to the load providing portion.

Additionally, the gait rehabilitation device according to an embodiment of the present disclosure further includes an abnormal situation detection portion to detect an abnormal situation of the human body, and a control portion to receive the abnormal situation of the human body from the abnormal situation detection portion, and control the rotation control portion to allow the rotation member to rotate relative to the load providing portion when the abnormal situation of the human body occurs.

Additionally, in the gait rehabilitation device according to an embodiment of the present disclosure, the load providing portion is a rotary damper.

Additionally, in the gait rehabilitation device according to an embodiment of the present disclosure, the side of the human body coupled to the load providing portion and the opposite side of the human body coupled to the rotation member are connected to a joint of the human body.

Additionally, in the gait rehabilitation device according to an embodiment of the present disclosure, the rotation control portion includes a coupling portion coupled to the rotation member and configured to linearly move, and as the coupling portion linearly moves, the coupling portion is inserted into a recess formed in the body or separated from the recess.

Additionally, in the gait rehabilitation device according to an embodiment of the present disclosure, the coupling portion is a solenoid stroke.

Additionally, the gait rehabilitation device according to an embodiment of the present disclosure further includes a displacement detection portion to detect a displacement of the body with respect to the rotation member, and a control portion to receive the displacement of the body with respect to the rotation member from the displacement detection portion, and insert the coupling portion into the recess when the coupling portion and the recess are aligned with each other.

Additionally, in the gait rehabilitation device according to an embodiment of the present disclosure, the displacement detection portion is a hall sensor or an imaging sensor.

Additionally, in the gait rehabilitation device according to an embodiment of the present disclosure, a plurality of the recesses is arranged at a predetermined interval along an outer circumferential surface of the body.

Additionally, in the gait rehabilitation device according to an embodiment of the present disclosure, the rotation control portion includes a coupling portion coupled to the rotation member and configured to linearly move, the body has a depression and a projection continuously formed along an outer circumferential surface, and as the coupling portion linearly moves, the coupling portion is inserted into or separated from the depression.

The features and advantages of the present disclosure will be apparent from the following detailed description based on the accompanying drawings.

Prior to the description, it should be understood that the terms or words used in the specification and the appended claims should not be construed as being limited to general and dictionary meanings, but rather interpreted based on the meanings and concepts corresponding to the technical spirit of the present disclosure on the basis of the principle that the inventor is allowed to define the concept of the terms appropriately for the best explanation.

According to the present disclosure, in the event of an abnormal situation, the rotation control portion operates to unlock the locking between the load providing portion and the rotation member to remove the load applied to the wearer to induce the wearer's free movement, thereby allowing the wearer to respond to the abnormal situation.

### BRIEF DESCRIPTION OF THE DRAWINGS

FIG. 1 is a side view of a wearer wearing a gait rehabilitation device according to an embodiment of the present disclosure.

FIGS. 2A and 2B are cross-sectional views of a gait rehabilitation device according to an embodiment of the present disclosure.

FIG. 3 is an exploded perspective view of a gait rehabilitation device according to an embodiment of the present disclosure.

FIG. 4 is an exploded perspective view of a gait rehabilitation device according to another embodiment of the present disclosure.

FIG. 5 is a cross-sectional view of a gait rehabilitation device according to another embodiment of the present disclosure.

FIG. 6 is an exploded perspective view of a gait rehabilitation device according to still another embodiment of the present disclosure.

FIG. 7 is a cross-sectional view of a gait rehabilitation device according to still another embodiment of the present disclosure.

### DETAILED DESCRIPTION

The objectives, particular advantages and new features of the present disclosure will be apparent from the following detailed description and exemplary embodiments associated with the accompanying drawings. In affixing the reference numbers to the elements of each drawing in the specification, it should be noted that the identical elements have the identical numbers as possible although they are shown in different drawings. Additionally, the term “first”, “second” or the like is used to distinguish one element from another, and the elements are not limited by the terms. Hereinafter, in describing the present disclosure, a detailed description of relevant known technology that makes the subject matter of the present disclosure unnecessarily ambiguous is omitted.

Hereinafter, an exemplary embodiment of the present disclosure will be described in detail with the reference to the accompanying drawings.

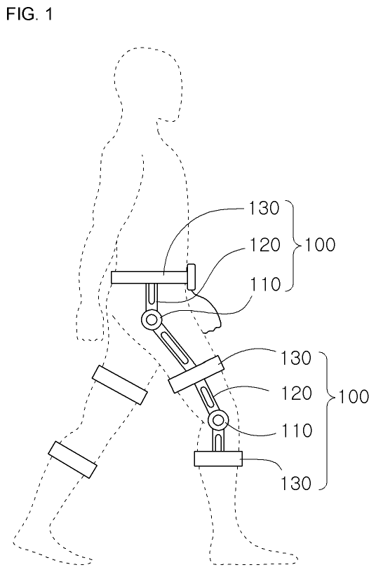

FIG. 1 is a side view of a wearer wearing a gait rehabilitation device according to an embodiment of the present disclosure.

Basically, the gait rehabilitation device according to this embodiment includes a mounting portion 100 mounted on a human body, and including a rotatable rotation portion 110 disposed at an area corresponding to the joint of the human body to provide a load to the joint of the human body (for example, the lower limb), an acceleration sensor fixed to the human body to measure 3-axis acceleration of the human body, an angular velocity sensor fixed to the human body to measure 3-axis angular velocity of the human body and an angle sensor to measure a joint angle of the human body by detecting a rotation angle of the rotation portion 110. Here, the mounting portion 100 is mounted on the human body (for example, the lower limb), and may include the rotation portion 110, a supporting portion 120 and a fastening portion 130. In this instance, the rotation portion 110 is disposed at the area corresponding to the joint (for example, the knee joint, the hip joint and the angle joint) of the human body. Additionally, the supporting portion 120 is extended to a predetermined length and coupled to the rotation portion 110. Additionally, the fastening portion 130 is coupled to a predetermined part of the supporting portion 120 and fastened to the human body (for example, the lower limb). For example, the fastening portion 130 may be fastened to the thigh, calf, waist and ankle.

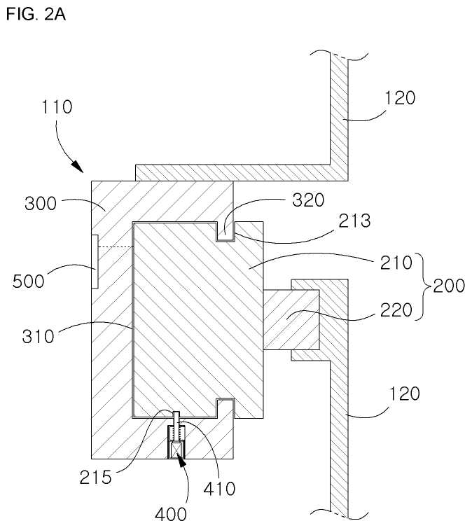

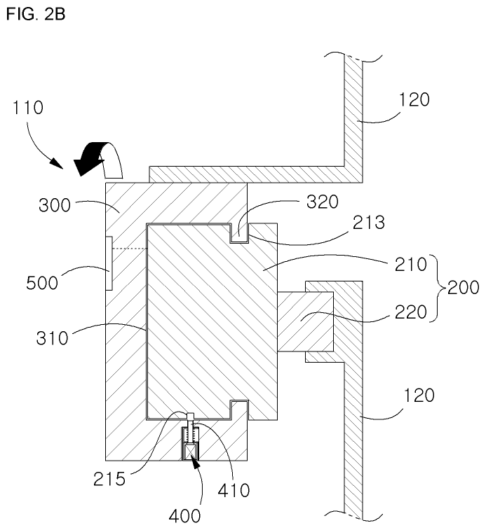

As described above, since the rotatable rotation portion 110 is disposed at the area corresponding to the joint of the human body, and the fastening portion 130 coupled to the supporting portion 120 is fastened to the human body (for example, the lower limb), when there is a change in the joint angle of the human body, the rotation portion 110 may rotate in response to the change in the joint angle of the human body. Here, a constant load is generated when the rotation portion 110 rotates, and rehabilitation may be performed by providing the load to the human body. In this instance, the load generated by the rotation portion 110 is adjustable, and the load provided to the joint may be adjusted as necessary. Meanwhile, the rotation portion 110 may include a load providing portion 200, a rotation member 300 and a rotation control portion 400 (see FIG. 2A), and its detailed description will be provided below.

Additionally, the acceleration sensor may be fixed to the human body to measure the 3-axis acceleration of the human body, and the angular velocity sensor may be fixed to the human body to measure the 3-axis angular velocity of the human body. A gait pattern may be analyzed through the 3-axis acceleration and the 3-axis angular velocity of the human body measured by the acceleration sensor and the angular velocity sensor. In this instance, the acceleration sensor and the angular velocity sensor may be provided in the mounting portion 100 and fixed to the human body together with the mounting portion 100.

Additionally, the angle sensor may measure the joint angle of the human body by detecting the rotation angle of the rotation portion 110. The gait pattern may be also analyzed through the joint angle of the human body measured by the angle sensor. In this instance, the angle sensor may be provided in the rotation portion 110.

The gait rehabilitation device according to this embodiment may not only perform rehabilitation by providing the load to the joint of the human body through the rotation portion 110, but also analyze the gait pattern through the acceleration sensor, the angular velocity sensor and the angle sensor.

Meanwhile, the acceleration sensor, the angular velocity sensor and the angle sensor may be an abnormal situation detection portion to detect an abnormal situation, for example, a human fall, and its detailed description will be provided below.

Hereinafter, the rotation portion 110 configured to remove the load applied to the wearer to induce the wearer's free movement in the event of the abnormal situation will be described in detail.

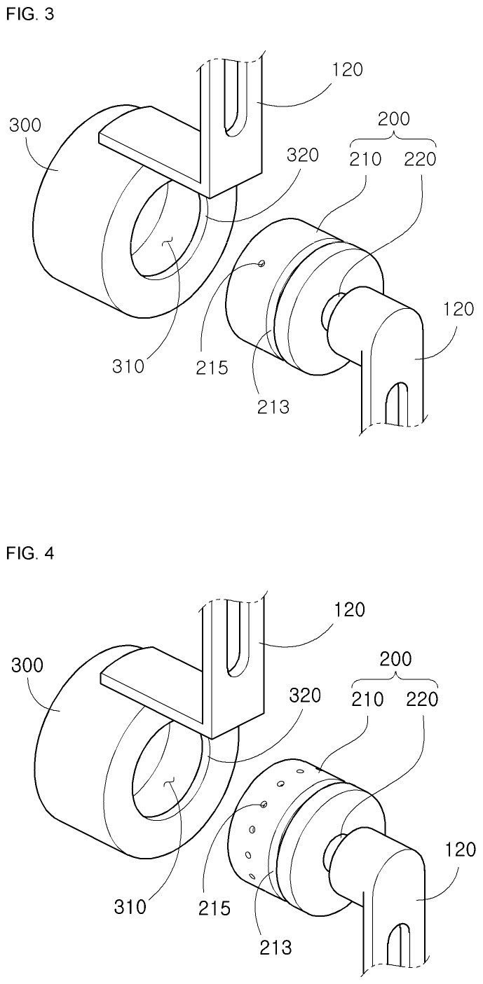

FIGS. 2A and 2B are cross-sectional views of the gait rehabilitation device according to an embodiment of the present disclosure, and FIG. 3 is an exploded perspective view of the gait rehabilitation device according to an embodiment of the present disclosure.

As shown in FIGS. 2A and 2B and FIG. 3, the gait rehabilitation device according to this embodiment includes the load providing portion 200 including a body 210 and a rotating shaft 220 which rotates relative to the body 210 to generate a load, wherein the rotating shaft 220 is coupled to one side of the human body, the rotation member 300 rotatably coupled to the body 210 and coupled to the other side of the human body, and the rotation control portion 400 to allow or disallow the rotation member 300 to rotate relative to the load providing portion 200.

Basically, the load providing portion 200, the rotation member 300 and the rotation control portion 400 may be provided in the above-described rotation portion 110.

The load providing portion 200 plays a substantial role in providing the load to the joint of the human body. Here, the load providing portion 200 may include the body 210, and the rotating shaft 220 which rotates relative to the body 210 to generate the load. In this instance, the body 210 may be cylindrical in shape, and may have a coupling groove 213 recessed in an annular shape along the outer circumferential surface for the rotatable coupling of the rotation member 300. Additionally, the rotating shaft 220 may be coupled to one side of the human body. For example, the supporting portion 120 may be coupled to the rotating shaft 220, and the supporting portion 120 may be coupled to one side (for example, the wearer's calf) of the human body through the fastening portion 130. Meanwhile, the load providing portion 200 is not limited to a particular type, but may be, for example, a rotary damper.

The rotation member 300 may be disallowed or allowed to rotate relative to the load providing portion 200 by the control of the rotation control portion 400. Here, the rotation member 300 may be rotatably coupled to the body 210 of the load providing portion 200. For example, the rotation member 300 may have an accommodation space 310 inside, and the body 210 of the load providing portion 200 may be received in the accommodation space 310. Additionally, the rotation member 300 may have a coupling protrusion 320 protruding in an annular shape along the inner circumferential surface of the accommodation space 310. When the coupling protrusion 320 is inserted into the coupling groove 213 formed in an annular shape along the outer circumferential surface of the body 210 of the load providing portion 200, the rotation member 300 may be rotatably coupled to the body 210 of the load providing portion 200. Meanwhile, the rotation member 300 may be coupled to the other side of the human body. For example, the supporting portion 120 may be coupled to the rotation member 300, and the supporting portion 120 may be coupled to the other side (for example, the wearer's thigh) of the human body through the fastening portion 130. As described above, the load providing portion 200 (the rotating shaft 220) is coupled to one side of the human body and the rotation member 300 is coupled to the other side of the human body, and one side and the other side of the human body may be connected to the joint of the human body. For example, when the load providing portion 200 (the rotating shaft 220) is coupled to the wearer's calf and the rotation member 300 is coupled to the wearer's thigh, the wearer's calf and thigh may be connected to the knee joint. Accordingly, when the rotation member 300 is disallowed to rotate relative to the load providing portion 200, the load providing portion 200 may provide the load to the joint of the human body.

The rotation control portion 400 plays a role in controlling the rotation of the rotation member 300 relative to the load providing portion 200. That is, the rotation control portion 400 may allow or disallow the rotation member 300 to rotate relative to the load providing portion 200. For example, in a normal situation, the rotation control portion 400 may prohibit the rotation of the load providing portion 200 relative to the rotation member 300 to provide the load of the load providing portion 200 to the joint of the human body (see FIG. 2A). However, in the event of an abnormal situation, for example, a human fall, the rotation control portion 400 may allow the rotation member 300 to rotate relative to the load providing portion 200 not to provide the load of the load providing portion 200 to the joint of the human body, inducing the wearer's free movement, thereby allowing the wearer to respond to the abnormal situation (see FIG. 2B).

Specifically, the rotation control portion 400 may include a coupling portion 410 coupled to the rotation member 300 and configured to linearly move. For example, the coupling portion 410 may linearly move such that one side is coupled to the inside of the rotation member 300 and the other side slides toward the body 210 of the load providing portion 200. In this instance, the coupling portion 410 is not limited to a particular type, but may be a solenoid stroke. Accordingly, the coupling portion 410 (for example, the solenoid stroke) may linearly move to slide according to an electrical signal. Additionally, the body 210 of the load providing portion 200 may have a recess 215 in the outer circumferential surface. Accordingly, as the coupling portion 410 linearly moves, the coupling portion 410 may be inserted into or separated from the recess 215 of the body 210. When the coupling portion 410 is inserted into the recess 215 of the body 210 (see FIG. 2A), the rotation member 300 is disallowed to rotate relative to the load providing portion 200, thereby providing the load of the load providing portion 200 to the joint of the human body. In contrast, when the coupling portion 410 is separated from the recess 215 of the body 210 (see FIG. 2B), the rotation member 300 is allowed to rotate relative to the load providing portion 200, and the load of the load providing portion 200 is not provided to the joint of the human body. Accordingly, in a normal situation, the coupling portion 410 is inserted into the recess 215 of the body 210, and the load of the load providing portion 200 is provided to the joint of the human body, but in the event of an abnormal situation, for example, a human fall, the coupling portion 410 is separated from the recess 215 of the body 210, and the load of the load providing portion 200 is not provided to the joint of the human body. Eventually, in the event of the abnormal situation, for example, the human fall, the load of the load providing portion 200 is not provided to the joint of the human body to induce the wearer's free movement, thereby allowing the wearer to respond to the abnormal situation.

In addition, the gait rehabilitation device according to this embodiment may include an abnormal situation detection portion and a control portion. Here, the abnormal situation detection portion plays a role in detecting an abnormal situation of the human body. The abnormal situation of the human body may be, for example, a human fall. Meanwhile, the abnormal situation detection portion may be the acceleration sensor, the angular velocity sensor or the angle sensor. For example, when the absolute value of the acceleration of the human body detected by the acceleration sensor is equal to or larger than a predetermined value, when the absolute value of the angular velocity of the human body detected by the angular velocity sensor is equal to or larger than a predetermined value, when the absolute value of the joint angle detected by the angle sensor is equal to or larger than a predetermined value, or when the absolute value of the speed of change of the joint angle detected by the angle sensor is equal to or larger than a predetermined value, the abnormal situation detection portion may detect the abnormal situation of the human body.

Meanwhile, the control portion may receive the abnormal situation of the human body from the abnormal situation detection portion, and in the event of the abnormal situation of the human body, may control the rotation control portion 400 to allow the rotation member 300 to rotate relative to the load providing portion 200. That is, when the abnormal situation detection portion detects the abnormal situation of the human body and transmits it to the control portion, the control portion may control the rotation control portion 400 to allow the rotation member 300 to rotate relative to the load providing portion 200 to induce the wearer's free movement, thereby allowing the wearer to respond to the abnormal situation.

Additionally, the gait rehabilitation device according to this embodiment may include a displacement detection portion 500. Here, the displacement detection portion 500 plays a role in detecting a relative displacement of the body 210 of the load providing portion 200 to the rotation member 300. In this instance, the control portion may receive the relative displacement of the body 210 to the rotation member 300 from the displacement detection portion 500, and insert the coupling portion 410 into the recess 215 again when the coupling portion 410 and the recess 215 are aligned with each other.

As described above, when the coupling portion 410 is separated from the recess 215 of the body 210, the rotation member 300 may rotate relative to the load providing portion 200. As described above, when the rotation member 300 rotates relative to the load providing portion 200, the coupling portion 410 and the recess 215 of the body 210 are not aligned with each other, failing to insert the coupling portion 410 into the recess 215 of the body 210 again. However, the relative displacement of the body 210 of the load providing portion 200 to the rotation member 300 may be detected through the displacement detection portion 500, and the control portion may receive the relative displacement of the body 210 to the rotation member 300 and accurately insert the coupling portion 410 into the recess 215 by moving the coupling portion 410 when the coupling portion 410 and the recess 215 are aligned with each other.

Meanwhile, the displacement detection portion 500 is not limited to a particular type, but may be, for example, a hall sensor or an imaging sensor. Specifically, in case that the displacement detection portion 500 is the hall sensor, the body 210 of the load providing portion 200 may have a magnet to allow the hall sensor to detect the displacement of the load providing portion 200 (the location of the recess 215). Accordingly, as the hall sensor detects the magnet provided in the body 210 of the load providing portion 200, the control portion may determine the time when the coupling portion 410 and the recess 215 are aligned with each other. Meanwhile, in case that the displacement detection portion 500 is the imaging sensor, a marker may be displayed on the body 210 of the load providing portion 200 to allow the imaging sensor to detect the displacement of the load providing portion 200 (the location of the recess 215). Accordingly, as the imaging sensor detects the marker displayed on the body 210 of the load providing portion 200, the control portion may determine the time when the coupling portion 410 and the recess 215 are aligned with each other.

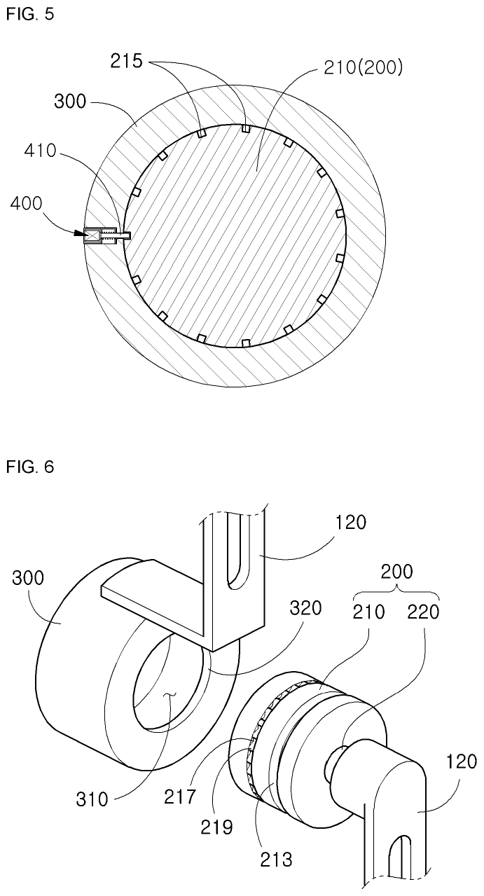

However, the number of recesses 215 in the outer circumferential surface of the body 210 of the load providing portion 200 is not necessarily one as described above. Alternatively, as shown in FIGS. 4 and 5, a plurality of recesses 215 may be continuously arranged at a predetermined interval along the outer circumferential surface of the body 210 of the load providing portion 200. In this instance, in case that the displacement detection portion 500 is the hall sensor, the corresponding number of magnets to the plurality of recesses 215 may be continuously arranged at the predetermined interval in the body 210 of the load providing portion 200. Accordingly, as the hall sensor detects the plurality of magnets provided in the body 210 of the load providing portion 200, the control portion may determine the time when the coupling portion 410 and any one of the plurality of recesses 215 are aligned with each other. On the other hand, in case that the displacement detection portion 500 is the imaging sensor, the corresponding number of markers to the plurality of recesses 215 may be continuously displayed at the predetermined interval on the body 210 of the load providing portion 200. Accordingly, as the imaging sensor detects the plurality of markers displayed on the body 210 of the load providing portion 200, the control portion may determine the time when the coupling portion 410 and any one of the plurality of recesses 215 are aligned with each other.

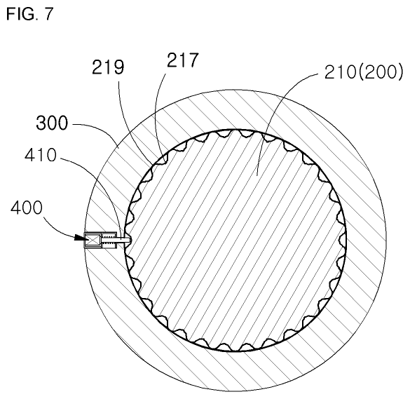

Meanwhile, the recess 215 is not necessarily formed in the outer circumferential surface of the body 210 of the load providing portion 200, and as shown in FIGS. 6 and 7, a depression 217 and a projection 219 may be continuously formed along the outer circumferential surface of the body 210 of the load providing portion 200. In this instance, the depression 217 and the projection 219 may be continuously extended in a curved shape. For example, the projection 219 may be extended in the curved shape with a smaller width in the outward direction, and the depression 217 may be extended in the curved shape with a smaller width in the inward direction. When viewed in cross section (see FIG. 7), the depression 217 and the projection 219 may be extended in a sine wave shape. In this instance, as the coupling portion 410 linearly moves, the coupling portion 410 may be inserted into or separated from the depression 217.

When the coupling portion 410 is inserted into the depression 217 of the body 210, basically, it is possible to prevent the rotation of the rotation member 300 relative to the load providing portion 200. However, when an abnormally strong moment occurs in the wearer's joint and the moment above a predetermined value is transmitted from the wearer's joint to the load providing portion 200 and the rotation member 300, the coupling portion 410 may move over the depression 217 and the projection 219 extended in the curved shape, and the rotation member 300 may rotate relative to the load providing portion 200. Eventually, when the abnormally strong moment occurs in the wearer's joint, the rotation member 300 rotates relative to the load providing portion 200, thereby preventing damage to the wearer's joint. Meanwhile, the wearer's joint moment that causes the rotation member 300 to rotate relative to the load providing portion 200 may change depending on the extent to which the coupling portion 410 is inserted into the depression 217 of the body 210.

While the present disclosure has been described in detail through the specific embodiments, this is to provide a detailed description of the present disclosure, and the present disclosure is not limited thereto, and it is obvious that modifications or changes may be made thereto by those having ordinary skill in the art within the technical spirit of the present disclosure.

Such modifications or changes to the present disclosure fall within the scope of the present disclosure, and the scope of protection of the present disclosure will be apparent from the appended claims.

### DETAILED DESCRIPTION OF THE MAIN ELEMENTS

| | |
|---|---|
| 100: Mounting portion | 110: Rotation portion |
| 120: Supporting portion | 130: Fastening portion |
| 200: Load providing portion | 210: Body |
| 213: Coupling groove | 215: Recess |
| 217: Depression | 219: Projection |
| 220: Rotating shaft | 300: Rotation member |
| 310: Accommodation space | 320: Coupling protrusion |
| 400: Rotation control portion | 410: Coupling portion |
| 500: Displacement detection portion | |

What is claimed is:

1. A gait rehabilitation device, comprising:
a load providing portion including a body and a rotating shaft which rotates relative to the body to generate a load, wherein the rotating shaft is coupled to a side of a human body;
a rotation member rotatably coupled to the body and coupled to an opposite side of the human body; and
a rotation control portion to allow or disallow the rotation member to rotate relative to the load providing portion.

2. The gait rehabilitation device according to claim 1, further comprising:
an abnormal situation detection portion to detect an abnormal situation of the human body; and
a control portion to receive the abnormal situation of the human body from the abnormal situation detection portion, and control the rotation control portion to allow the rotation member to rotate relative to the load providing portion when the abnormal situation of the human body occurs.

3. The gait rehabilitation device according to claim 1, wherein the load providing portion is a rotary damper.

4. The gait rehabilitation device according to claim 1, wherein the side of the human body coupled to the load providing portion and the opposite side of the human body coupled to the rotation member are connected to a joint of the human body.

5. The gait rehabilitation device according to claim 1, wherein the rotation control portion includes a coupling portion coupled to the rotation member and configured to linearly move, and
wherein as the coupling portion linearly moves, the coupling portion is inserted into a recess formed in the body or separated from the recess.

6. The gait rehabilitation device according to claim 5, wherein the coupling portion is a solenoid stroke.

7. The gait rehabilitation device according to claim 5, further comprising:
a displacement detection portion to detect a displacement of the body with respect to the rotation member; and
a control portion to receive the displacement of the body with respect to the rotation member from the displacement detection portion, and insert the coupling portion into the recess when the coupling portion and the recess are aligned with each other.

8. The gait rehabilitation device according to claim 7, wherein the displacement detection portion is a hall sensor or an imaging sensor.

9. The gait rehabilitation device according to claim 5, wherein a plurality of the recesses is arranged at a predetermined interval along an outer circumferential surface of the body.

10. The gait rehabilitation device according to claim 1, wherein the rotation control portion includes a coupling portion coupled to the rotation member and configured to linearly move, and
wherein the body has a depression and a projection continuously formed along an outer circumferential surface, and as the coupling portion linearly moves, the coupling portion is inserted into or separated from the depression.
